(19) United States
(12) Patent Application Publication
(10) Pub. No.: US 2025/0023267 A1
(43) Pub. Date: Jan. 16, 2025

(54) BOARD CONNECTOR

(71) Applicant: Yazaki Corporation, Tokyo (JP)

(72) Inventor: Tomohiko WATANABE, Shizuoka (JP)

(73) Assignee: Yazaki Corporation, Tokyo (JP)

(21) Appl. No.: 18/763,476

(22) Filed: Jul. 3, 2024

(30) Foreign Application Priority Data
Jul. 10, 2023 (KR) 2023-112948

(51) Int. Cl. H01R 12/72; H01R 13/11; H01R 13/42

(52) U.S. Cl. CPC H01R 12/724; H01R 13/11; H01R 13/42

(57) ABSTRACT

A board connector includes a housing and a terminal, and the terminal includes a terminal main body, a coupling portion, and a board connection portion. Further, the coupling portion includes a first coupling portion, and the first coupling portion includes a reinforcement portion having a cross-sectional shape with a bending portion, the cross-sectional shape being taken along a plane orthogonal to one direction. Further, the reinforcement portion includes an exposure portion formed from another end of the first coupling portion to an insertion opening of an insertion space while the terminal is held by the housing. Further, the reinforcement portion includes an insertion portion being provided continuously to the exposure portion and being inserted to the insertion space.

### CROSS-REFERENCE TO RELATED APPLICATIONS

The present application is based on, and claims priority from the prior Japanese Patent Application No. 2023-112948, filed on Jul. 10, 2023, the entire contents of which are incorporated herein by reference.

### TECHNICAL FIELD

The present disclosure relates to a board connector.

### BACKGROUND

In the related art, JP2021-026801A discloses a board connector of this type. In JP2021-026801A, a board connector to be attached to a circuit board is discloses.

The board connector includes a housing that includes a hood portion opening frontward and a terminal insertion hole formed in a rear wall of the hood portion. Further, the board connector includes a terminal that includes a terminal contact portion arranged in the hood portion and an insertion portion inserted in the terminal insertion hole. The terminal further includes a lead-out portion that is lead out rearward from the terminal insertion hole, a descending portion that extends obliquely downward and rearward from a rear end of the lead-out portion, and a board connection portion that is formed at a lower end of the descending portion and is connected to a circuit board.

Further, a press-fit portion and a second press-fit portion that protrude in directions intersecting with each other are provided to the insertion portion, and the press-fit portion and the second press-fit portion are press-fitted into an inner wall of the terminal insertion hole. In this manner, positioning between the terminal and the housing is performed.

### SUMMARY OF THE INVENTION

However, in the related art described above, the lead-out portion, the descending portion, and the board connection portion are exposed to the outside of the housing while the terminal is attached to the housing, and a terminal exposure portion including the lead-out portion, the descending portion, and the board connection portion is formed to have a flat plate-like shape having a small plate thickness. Thus, the board connection portion formed at the distal end of the terminal exposure portion easily sways in an up-and-down direction or a right-and-left direction. When the board connection portion sways in the up-and-down direction or the right-and-left direction, there may be a risk that the position of the board connection portion varies. In this manner, in the related art described above, it is difficult to improve positioning accuracy of the board connection portion.

An object of the disclosure is to provide a board connector that can improve positioning accuracy of a board connection portion fixed to a circuit board.

A board connector according to an aspect of the present disclosure includes a housing in which an insertion space passing therethrough in one direction is formed, and a terminal being inserted in the insertion space and being held by the housing, wherein the terminal includes a terminal main body being inserted to the insertion space, a board connection portion being connected to a circuit board while being exposed from the housing, and a coupling portion that couples the terminal main body and the board connection portion to each other, the coupling portion includes a first coupling portion having one end extending in the one direction and being coupled to the terminal main body and another end being exposed from the housing, a second coupling portion extending in a direction intersecting with the one direction and being coupled to the board connection portion, and a third coupling portion coupling the first coupling portion and the second coupling portion to each other, the first coupling portion includes a reinforcement portion having a cross-sectional shape with a bending portion, the cross-sectional shape being taken along a plane orthogonal to the one direction, and the reinforcement portion includes an exposure portion formed from the another end of the first coupling portion to an insertion opening of the insertion space while the terminal is held by the housing, and an insertion portion being provided continuously to the exposure portion and being inserted to the insertion space.

According to the present disclosure, it is possible to provide a board connector that can improve positioning accuracy of a board connection portion fixed to a circuit board.

### BRIEF DESCRIPTION OF DRAWINGS

FIG. 1 is a perspective view schematically illustrating one example of a board connector according to an embodiment.

FIG. 2 is a vertically cross-sectional view schematically illustrating a state in which one example of the board connector according to the embodiment is fitted into one example of a mating connector.

FIG. 3 is a perspective view schematically illustrating a state before one example of a terminal according to the embodiment is inserted to a corresponding housing.

FIG. 4 is a diagram for describing a relationship between a horizontally cross-sectional shape of one example of the terminal according to the embodiment and a shape of a terminal insertion hole formed in the corresponding housing.

FIG. 5 is perspective view schematically illustrating a state before a first modification example of the terminal according to the embodiment is inserted to the corresponding housing.

FIG. 6 is a diagram for describing a relationship between a horizontally cross-sectional shape of a first modification example of the terminal according to the embodiment and the shape of the terminal insertion hole formed in the corresponding housing.

FIG. 7 is a diagram for describing a relationship between a horizontally cross-sectional shape of a second modification example of the terminal according to the embodiment and the shape of the terminal insertion hole formed in the corresponding housing.

FIG. 8 is a diagram for describing a relationship between a horizontally cross-sectional shape of a third modification example of the terminal according to the embodiment and the shape of the terminal insertion hole formed in the corresponding housing.

FIG. 9 is a diagram for describing a relationship between a horizontally cross-sectional shape of a fourth modification example of the terminal according to the embodiment and the shape of the terminal insertion hole formed in the corresponding housing.

FIG. 10 is a diagram for describing a relationship between a horizontally cross-sectional shape of a fifth modification example of the terminal according to the embodiment and the shape of the terminal insertion hole formed in the corresponding housing.

FIG. 11 is a diagram for describing a relationship between a horizontally cross-sectional shape of a sixth modification example of the terminal according to the embodiment and the shape of the terminal insertion hole formed in the corresponding housing.

FIG. 12 is a diagram for describing a relationship between a horizontally cross-sectional shape of a seventh modification example of the terminal according to the embodiment and the shape of the terminal insertion hole formed in the corresponding housing.

FIG. 13 is a diagram for describing a relationship between a horizontally cross-sectional shape of an eighth modification example of the terminal according to the embodiment and the shape of the terminal insertion hole formed in the corresponding housing.

FIG. 14 is a diagram for describing a relationship between a horizontally cross-sectional shape of a ninth modification example of the terminal according to the embodiment and the shape of the terminal insertion hole formed in the corresponding housing.

FIG. 15 is a diagram for describing a relationship between a horizontally cross-sectional shape of a tenth modification example of the terminal according to the embodiment and the shape of the terminal insertion hole formed in the corresponding housing.

FIG. 16 is a diagram for describing a relationship between a horizontally cross-sectional shape of an eleventh modification example of the terminal according to the embodiment and the shape of the terminal insertion hole formed in the corresponding housing.

FIG. 17 is a diagram for describing a relationship between a horizontally cross-sectional shape of a twelfth modification example of the terminal according to the embodiment and the shape of the terminal insertion hole formed in the corresponding housing.

FIG. 18 is a diagram for describing a relationship between a horizontally cross-sectional shape of a thirteenth modification example of the terminal according to the embodiment and the shape of the terminal insertion hole formed in the corresponding housing.

FIG. 19 is a diagram for describing a relationship between a horizontally cross-sectional shape of a fourteenth modification example of the terminal according to the embodiment and the shape of the terminal insertion hole formed in the corresponding housing.

FIG. 20 is a diagram for describing a relationship between a horizontally cross-sectional shape of a fifteenth modification example of the terminal according to the embodiment and the shape of the terminal insertion hole formed in the corresponding housing.

### DETAILED DESCRIPTION OF THE INVENTION

Various embodiments will be described hereinafter with reference to the accompanying drawings.

A board connector according to the present embodiment is described below in detail with reference to the drawings. Note that the dimension ratios in the drawings are exaggerated for the convenience of the description, and may be different from the actual ratios.

Description is made below while defining, as an X direction (front-and-rear direction: one direction), a direction in which a terminal moves relatively with respect to a housing when the terminal is inserted to the housing. Further, description is made below while defining, as a Y direction (width direction), a direction in which a plurality of terminals are arrayed when the terminals are held by the housing. Further, description is made while defining an up-and-down direction of each member in a state in which a circuit board to which a board connector is attached is arranged so that the board connector is positioned on an upper side and the circuit board is positioned on a lower side.

Further, the board connector is described while defining, as a front side (one side) in the front-and-rear direction (one direction), a side of the board connector that faces a mating connector at the time of fitting into the mating connector. Further, the mating connector is described while defining as a front side (one side) in the front-and-rear direction (one direction), a side of the mating connector that faces the board connector at the time of fitting into the board connector.

Further, the following embodiment and the modification examples thereof include similar constituent elements. Thus, in the following description, the similar constituents are denoted with common reference symbols, and overlapping description therefor is omitted.

A board connector 1 according to the present embodiment is attached to an FPC board 2 being a flexible circuit board, and is configured to be fitted into a mating connector 3 while being attached to the FPC board 2. The board connector 1 includes a housing 1a in which a plurality of insertion spaces passing therethrough in the X direction (front-and-rear direction: one direction) are formed, and terminals that are inserted to the insertion spaces and are held by the housing 1a.

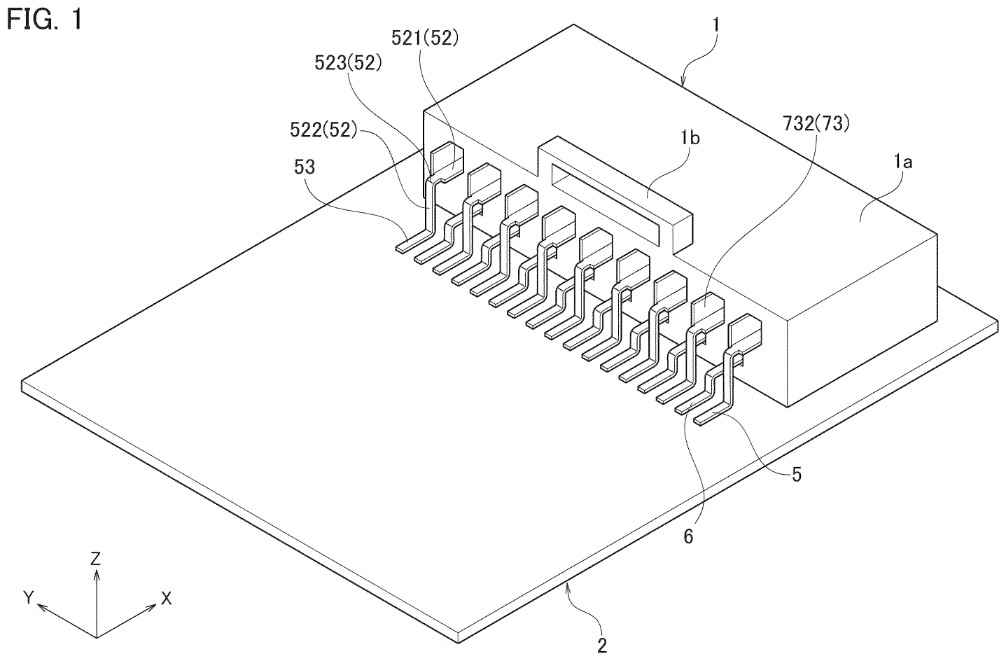

As illustrated in FIG. 1, the housing 1a is formed to have a rectangular parallelepiped shape elongated in the Y direction (width direction), and has rigidity. For example, the housing 1a may be formed by using an insulating resin material.

Further, at two positions including an upper part and a lower part of the housing 1a, the plurality of insertion spaces are formed to be arrayed at a predetermined pitch in the Y direction (width direction). In this manner, in the present embodiment, the housing 1a, two upper and lower insertion spaces, in other words, an upper insertion space S1 positioned on the upper side of the housing 1a and a lower insertion space S2 positioned on the lower side of the housing 1a are formed.

Further, an upper terminal 5 is inserted from an upper insertion opening Sla opening in the rear surface of the housing 1a to the upper insertion space S1, and a lower terminal 6 is inserted from a lower insertion opening S2a to a lower insertion space S2. Note that the front opening of the upper insertion space S1 corresponds to an upper introduction opening S1b to which a terminal main body 81 of a mating upper terminal 8, which is described later, is introduced. Similarly, the front opening of the lower insertion space S2 corresponds to a lower introduction opening S2b to which a terminal main body 91 of a mating lower terminal 9, which is described later, is introduced.

In this manner, in the present embodiment, the upper terminal 5 is inserted to the upper insertion space S1, the lower terminal 6 is inserted to the lower insertion space S2, and then the respective terminals are held by the housing 1a. As a result, the board connector 1 is formed. Further, the housing 1a and the terminal are fixed to the FPC board 2 while the terminal (upper terminal 5, lower terminal 6) is held by the housing 1a. In this manner, the board connector 1 is attached to the FPC board 2. Note that, for example, fixation of the housing 1a to the FPC board 2 may be performed by fixing a fixing tool assembled to the housing 1a to the FPC board 2 through soldering or the like.

The terminal (upper terminal 5, lower terminal 6) includes a terminal main body 51, 61 that is inserted to the insertion space (upper insertion space S1, lower insertion space S2) and a substrate connection portion 53, 63 that is connected to the FPC substrate (circuit board) 2 while being exposed from the housing 1a. Further, the terminal (upper terminal 5, lower terminal 6) includes a coupling portion 52, 62 that couples the terminal main body 51, 61 and the substrate connection portion 53, 63 to each other.

For example, a metal material having a flat plate-like shape is subjected to a punching process so that an outer shape of the material is a predetermined shape, and a processed product thus obtained after the punching process is appropriately subjected to a plastic process such as bending. In this manner, the terminal (upper terminal 5, lower terminal 6) may be formed.

Further, the terminal main body 51, 61 includes a cylindrical box portions 511, 611 that has a space formed therein and a neck portion 512, 612 that is formed between the box portion 511, 611 and the coupling portion 52, 62. Further, in the space of the box portion 511, 611, a contact portion 511a, 611a is formed.

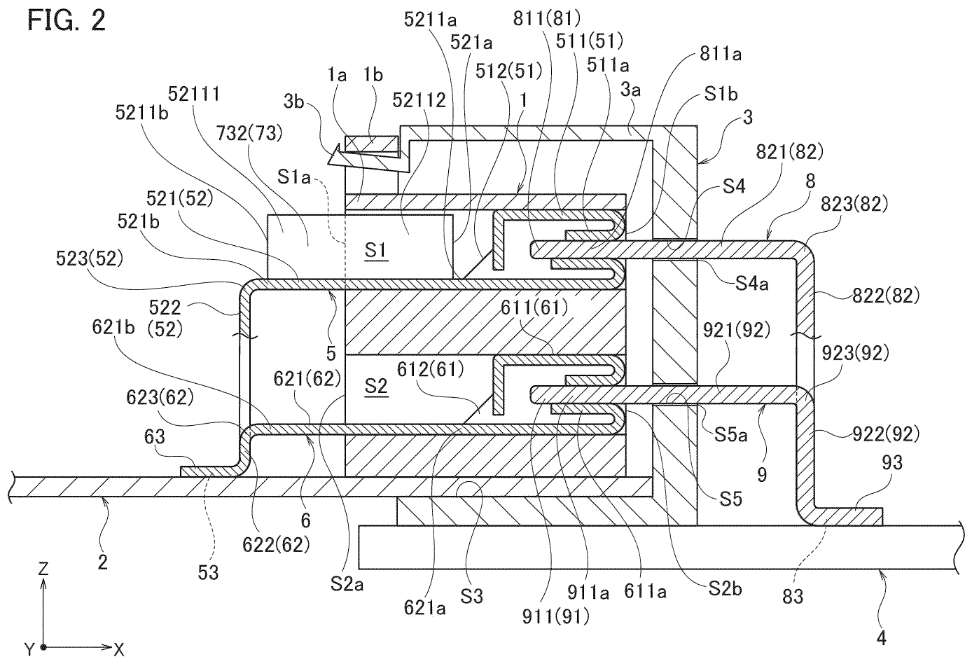

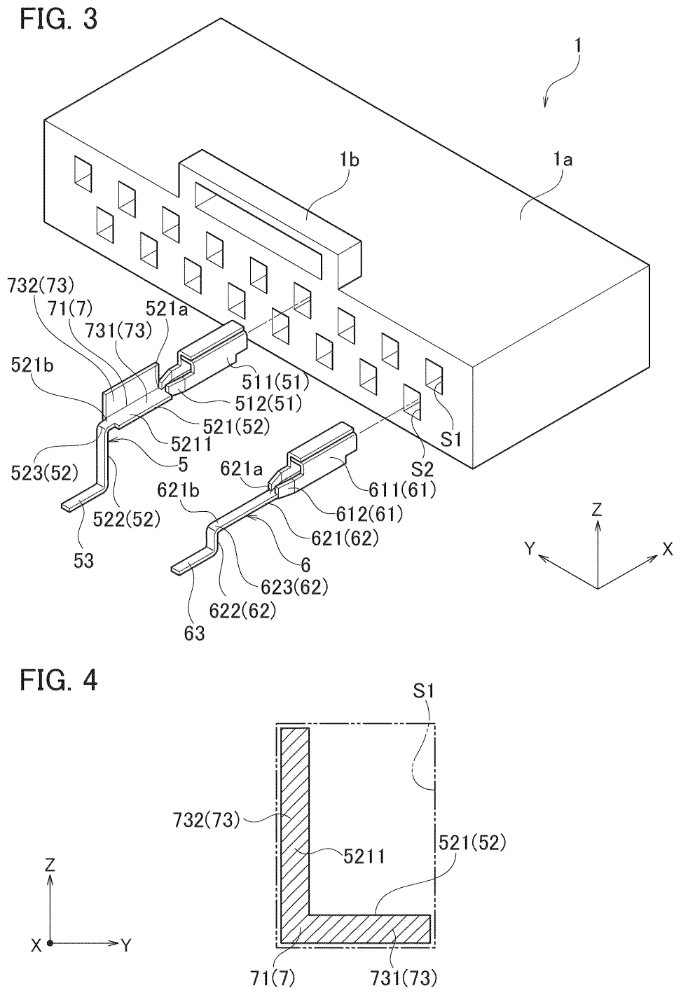

Further, as illustrated in FIG. 2 and FIG. 3, the coupling portion 52, 62 includes a first coupling portion 521, 621 having one end 521a, 621a that extends in the X direction (one direction) and is couple to the terminal main body 51, 61 and the other end 521b, 621b that is exposed from the housing 1a. Further, the coupling portion 52, 62 includes the second coupling portion 522, 622 that extends in a Z direction (a direction intersection with the X direction being the one direction) and is coupled to the substrate connection portion 53, 63. Moreover, the coupling portion 52, 62 includes a third coupling portion 523, 623 that couples the first coupling portion 521, 621 and the second coupling portion 522, 622 to each other.

Note that in the present embodiment, a portion (terminal exposure portion) of the coupling portion 52, 62 and the substrate connection portion 53, 63 that is exposed from the housing 1a is formed to have a crank-like shape, and the substrate connection portion 53, 63 is formed at the distal end of the terminal exposure portion.

Further, when the board connector 1 is attached to the FPC board 2, the substrate connection portion 53, 63 is fixed to a conductive pattern formed on the FPC board 2, which is omitted in illustration, through soldering or the like. With this, each terminal of the board connector 1 is electrically connected to the conductive pattern of the FPC board 2.

Further, the board connector 1 to which the FPC board 2 is attached is fitted into the mating connector 3, and thus the terminal (upper terminal 5, lower terminal 6) is electrically connected to the mating terminal (mating upper terminal 8, mating lower terminal 9).

As illustrated in FIG. 2, the mating connector 3 includes a mating housing 3a, and a fitting space S3 is formed in the mating housing 3a. In the fitting space S3, the board connector 1 to which the FPC board 2 is attached is inserted.

Note that a lock lever 3b is formed at the upper part of the mating housing 3a, and the lock lever 3b is locked with a lock portion 1b formed at the upper part of the housing 1a. With this, the housing 1a and the mating housing 3a are locked with each other in a fitting state.

Note that the mating housing 3a is also formed to have a rectangular parallelepiped shape elongated in the Y direction (width direction), and has rigidity. The mating housing 3a may also be formed by using an insulating resin material.

Further, in the mating housing 3a, two upper and lower insertion spaces, in other words, an upper insertion space S4 positioned on the upper side of the mating housing 3a and a lower insertion space S5 positioned on the lower side of the mating housing 3a are similarly formed. The upper insertion space S4 and the lower insertion space S5 are formed at positions corresponding to the upper insertion space S1 and the lower insertion space S2 of the housing 1a, respectively.

Further, the mating upper terminal 8 is inserted from an upper insertion opening S4a opening in the rear surface of the mating housing 3a to the upper insertion space S4, and the mating lower terminal 9 is inserted from a lower insertion opening S5a to the lower insertion space S5.

In this manner, in the present embodiment, the mating upper terminal 8 is inserted to the upper insertion space S4, the mating lower terminal 9 is inserted to the lower insertion space S5, and then the respective terminals are held by the mating housing 3a. As a result, the mating connector 3 is formed. Further, the mating housing 3a and the terminal are fixed to a printed circuit board 4 while the terminal (mating upper terminal 8, mating lower terminal 9) is held by the mating housing 3a. In this manner, the mating connector 3 is attached to the printed circuit board 4. Note that, for example, fixation of the mating housing 3a to the printed circuit board 4 may be performed by fixing a fixing tool assembled to the mating housing 3a to the printed circuit board 4 through soldering or the like.

The mating terminal (upper terminal 8, lower terminal 9) includes the terminal main body 81,91 that is inserted to the insertion space (upper insertion space S4, lower insertion space S5) and a board connection portion 83, 93 that is connected to the printed circuit board 4 while being exposed from the mating housing 3a. Further, the mating terminal (upper terminal 8, lower terminal 9) includes a coupling portion 82, 92 that couples the terminal main body 81, 91 and the board connection portion 83, 93 to each other.

For example, a metal material having a flat plate-like shape is subjected to a punching process so that an outer shape of the material is a predetermined shape, and a processed product thus obtained after the punching process is appropriately subjected to a plastic process such as bending. In this manner, the mating terminal (upper terminal 8, lower terminal 9) may also be formed.

Further, the terminal main body 81, 91 includes a tab 811, 911, and a mating contact portion 811a, 911a that contacts with the contact portion 511a, 611a in a fitting state between the board connector 1 and the mating connector 3 is formed at the tab 811, 911.

Further, as illustrated in FIG. 2, the coupling portion 82, 92 includes a first coupling portion 821, 921 having one end that extends in the X direction (one direction) and is coupled to the terminal main body 81, 91 and the other end that is exposed from the mating housing 3a. Further, the coupling portion 82, 92 includes a second coupling portion 822, 922 that extends in the Z direction (a direction intersection with the X direction being the one direction) and is coupled to the board connection portion 83, 93. Moreover, the coupling portion 82, 92 includes a third coupling portion 823, 923 that couples the first coupling portion 821, 921 and the second coupling portion 822, 922 to each other.

Note that in the present embodiment, a portion (terminal exposure portion) of the coupling portion 82, 92 and the board connection portion 83, 93 that is exposed from the mating housing 3a is also formed to have a crank-like shape, and the board connection portion 83, 93 is formed at the distal end of the terminal exposure portion.

Further, when the mating connector 3 is attached to the printed circuit board 4, the board connection portion 83, 93 is fixed to a conductive pattern formed on the printed circuit board 4, which is omitted in illustration, through soldering or the like. With this, each terminal of the mating connector 3 is electrically connected to the conductive pattern of the printed circuit board 4.

Herein, in the present embodiment, positioning accuracy of the substrate connection portion 53 fixed to the FPC substrate (circuit board) 2 can be improved more.

Specifically, the first coupling portion 521 includes a reinforcement portion 5211 having a cross-sectional shape with a bending portion 7, the cross-sectional shape being taken along a plane (YZ plane) orthogonal to the X direction (one direction).

Further, the reinforcement portion 5211 includes an exposure portion 52111 formed from the other end 521b of the first coupling portion 521 to the insertion opening Sla of the insertion space S1 while the upper terminal (terminal) 5 is held by the housing 1a. Moreover, the reinforcement portion 5211 includes an insertion portion 52112 that is provided continuously to the exposure portion 52111 and is inserted to the insertion space S1.

In this manner, in the present embodiment, the first coupling portion 521 includes the reinforcement portion 5211 having a cross-sectional shape with the bending portion 7, the cross-sectional shape being taken along the plane orthogonal to the X direction (one direction). With this, as compared to a terminal having a rectangular cross-sectional shape taken along the plane orthogonal to the X direction (one direction), a cross-sectional secondary moment is increased, and thus the upper terminal (terminal) 5 is less likely to move.

Further, while the upper terminal (terminal) 5 is held by the housing 1a, the reinforcement portion 5211 from the other end 521b of the first coupling portion 521 to the inside of the insertion space S1 is formed. In other words, the reinforcement portion 5211 having a cross-sectional shape with the bending portion 7 is formed not only outside the housing 1a but also inside the insertion space S1. With this, the reinforcement portion 5211 can be supported by the housing 1a, and hence the entire part of the upper terminal (terminal) 5, which protrudes from the housing 1a, is less likely to move. With this, the substrate connection portion 53 formed at the distal end of the upper terminal (terminal) 5 can be prevented more securely from swaying in the up-and-down direction or a right-and-left direction, and positioning accuracy of the substrate connection portion 53 can be improved more.

Further, in the present embodiment, the bending portion 7 includes a bent portion 71. Specifically, as illustrated in FIG. 4, the reinforcement portion 5211 is formed so that the cross-sectional shape taken along the plane (YZ plane) orthogonal to the X direction (one direction) is a substantially L-like shape including two linear portions 73 (a horizontally linear portion 731 and a vertically linear portion 732) and one bent portion 71.

Moreover, in the present embodiment, the reinforcement portion 5211 having a substantially L-like cross-sectional shape is formed from the one end 521a of the first coupling portion 521 to the other end 521b. Therefore, in the present embodiment, one end 5211a of the reinforcement portion 5211 and the one end 521a of the first coupling portion 521 substantially match with each other, and the other end 5211b of the reinforcement portion 5211 and the other end 521b of the first coupling portion 521 substantially match with each other. In other words, the first coupling portion 521 has a uniform cross-sectional shape (substantially L-like shape) from the one end 521a to the other end 521b.

In this manner, when the reinforcement portion 5211 is formed so that the cross-sectional shape taken along the plane orthogonal to the X direction (one direction) includes the bent portion 71, positioning accuracy of the substrate connection portion 53 can be improved with a simpler configuration.

Further, the L-like shape is a shape that can be formed by one bending process, has satisfactory bending processability at the time of manufacturing, and is less prone to cracking. Thus, such a shape can be manufactured easily.

Further, when the cross-sectional shape of the reinforcement portion 5211 is formed into a substantially L-like shape, the pitch in the vertical direction and the pitch between the terminals can be reduced. Moreover, an extended lifespan of a mold die can be achieved.

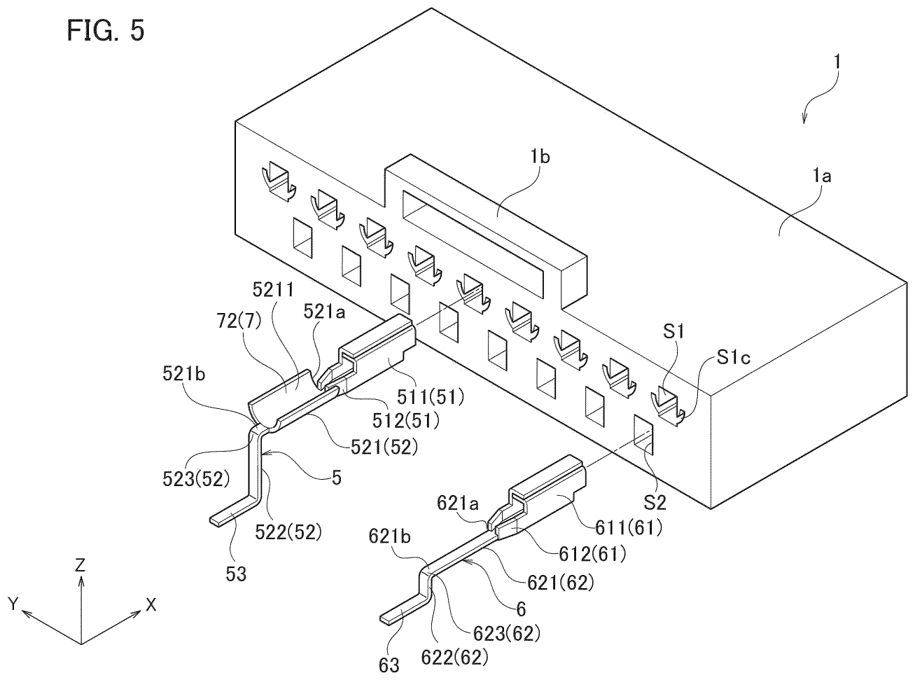

Note that the cross-sectional shape of the reinforcement portion 5211, which is taken along the plane orthogonal to the X direction (one direction), may be formed into various shapes. The modification examples of the cross-sectional shape of the reinforcement portion 5211 are described below with reference to FIG. 5 to FIG. 20. However, the shapes illustrated in FIG. 5 to FIG. 20 are also merely examples, and other shapes may be adopted.

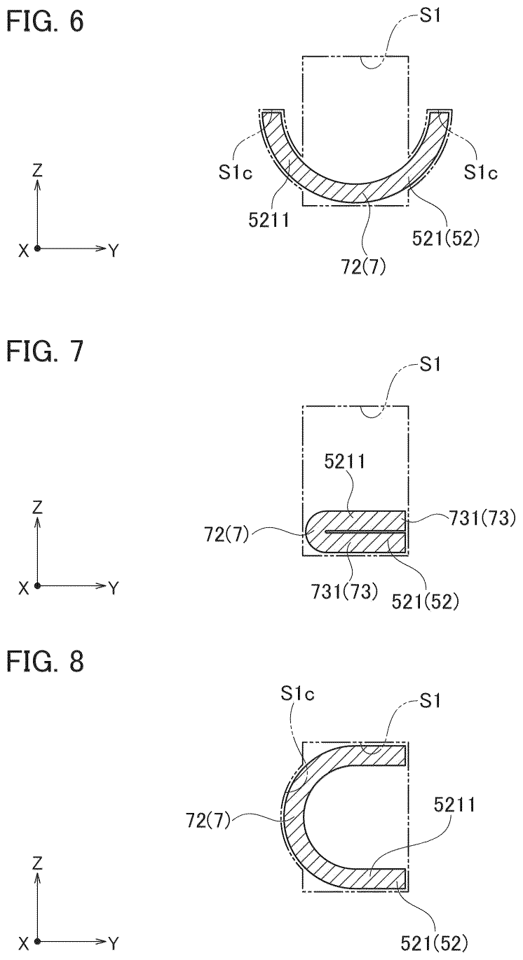

The cross-sectional shape of the reinforcement portion 5211 may be a shape illustrated in FIG. 5 and FIG. 6. In a case of the reinforcement portion 5211 illustrated in FIG. 5 and FIG. 6, the cross-sectional shape taken along the plane (YZ plane) orthogonal to the X direction (one direction) also includes the bending portion 7.

Herein, in the reinforcement portion 5211 illustrated in FIG. 5 and FIG. 6, the bending portion 7 includes the curved portion 72. Specifically, the cross-sectional shape of the reinforcement portion 5211 is formed into a substantially U-like shape (semi-circular shape) including one curved portion 72.

Moreover, in FIG. 5 and FIG. 6, the width of the reinforcement portion 5211 (the length in the Y direction) is larger than the width of the terminal main body 51, and hence an expansion space S1c having a shape corresponding to the cross-sectional shape of the reinforcement portion 5211 is formed in the upper insertion space S1.

With this, the upper terminal (terminal) 5 held by the housing 1a can be prevented more securely from rotating in the housing 1a, and positioning accuracy the substrate connection portion 53 attached to the FPC substrate (circuit board) 2 can be improved more.

Such a U-like shape is a shape that has satisfactory bending processability at the time of manufacturing and is less prone to wrinkling. Thus, such a shape can be manufactured easily.

Further, by forming the cross-sectional shape of the reinforcement portion 5211 into a substantially U-like shape, an extended lifespan of a mold die can be achieved.

Note that the reinforcement portion 5211 illustrated in FIG. 5 and FIG. 6 can also have a uniform cross-sectional shape from the one end 521a of the first coupling portion 521 to the other end 521b.

Further, the cross-sectional shape of the reinforcement portion 5211 may be a shape illustrated in FIG. 7. In a case of the reinforcement portion 5211 illustrated in FIG. 7, the cross-sectional shape taken along the plane (YZ plane) orthogonal to the X direction (one direction) also includes the bending portion 7.

Herein, in the reinforcement portion 5211 illustrated in FIG. 7, the bending portion 7 includes the curved portion 72. Specifically, the cross-sectional shape of the reinforcement portion 5211 is formed into a substantially I-like shape (stacking structure) including one curved portion 72.

Such an I-like shape is a shape that can be formed by one bending process and is less prone to cracking at the time of manufacturing. Thus, such a shape can be manufactured easily.

Further, when the cross-sectional shape of the reinforcement portion 5211 is formed into a substantially I-like shape, the pitch in the vertical direction and the pitch between the terminals can be reduced. Moreover, an extended lifespan of a mold die can be achieved.

Note that the reinforcement portion 5211 illustrated in FIG. 7 can also have a uniform cross-sectional shape from the one end 521a of the first coupling portion 521 to the other end 521b.

Further, the cross-sectional shape of the reinforcement portion 5211 may be a shape illustrated in FIG. 8. In a case of the reinforcement portion 5211 illustrated in FIG. 8, the cross-sectional shape taken along the plane (YZ plane) orthogonal to the X direction (one direction) also includes the bending portion 7.

Herein, in the reinforcement portion 5211 illustrated in FIG. 8, the bending portion 7 includes the curved portion 72. Specifically, the cross-sectional shape of the reinforcement portion 5211 is formed into a substantially C-like shape including one curved portion 72.

Moreover, in FIG. 8, the width of the reinforcement portion 5211 (the length in the Y direction) is larger than the width of the terminal main body 51, and hence the expansion space S1c having a shape corresponding to the cross-sectional shape of the reinforcement portion 5211 is formed in the upper insertion space S1.

Such a C-like shape is a shape that has satisfactory bending processability at the time of manufacturing and is less prone to wrinkling. Thus, such a shape can be manufactured easily.

Further, by forming the cross-sectional shape of the reinforcement portion 5211 into a substantially C-like shape, an extended lifespan of a mold die can be achieved.

Note that the reinforcement portion 5211 illustrated in FIG. 8 can also have a uniform cross-sectional shape from the one end 521a of the first coupling portion 521 to the other end 521b.

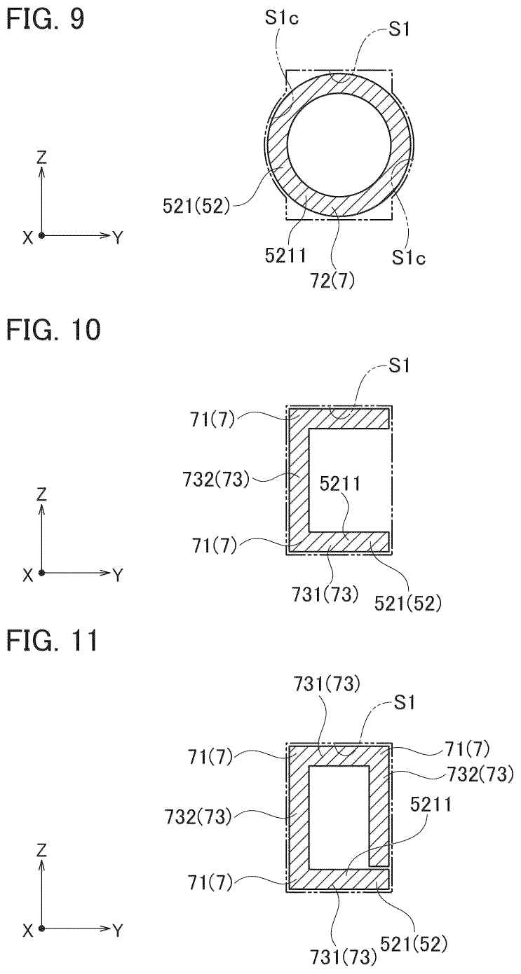

Further, the cross-sectional shape of the reinforcement portion 5211 may be a shape illustrated in FIG. 9. In a case of the reinforcement portion 5211 illustrated in FIG. 9, the cross-sectional shape taken along the plane (YZ plane) orthogonal to the X direction (one direction) also includes the bending portion 7.

Herein, in the reinforcement portion 5211 illustrated in FIG. 9, the bending portion 7 includes the curved portion 72. Specifically, the cross-sectional shape of the reinforcement portion 5211 is formed into a substantially O-like shape including one curved portion 72.

Moreover, in FIG. 9, the width of the reinforcement portion 5211 (the length in the Y direction) is larger than the width of the terminal main body 51, and hence the expansion space S1c having a shape corresponding to the cross-sectional shape of the reinforcement portion 5211 is formed in the upper insertion space S1.

For example, such an O-like shape can be formed by curving one metal plate into an annular shape. Further, the shape is less prone to cracking at the time of manufacturing. Thus, such a shape can be manufactured easily.

Further, when the cross-sectional shape of the reinforcement portion 5211 is formed into a substantially O-like shape, stability in the up-and-down direction and stability in the right-and-left direction can be enhanced. Further, the pitch in the vertical direction and the pitch between the terminals can be reduced. Moreover, an extended lifespan of a mold die can be achieved.

Note that the reinforcement portion 5211 illustrated in FIG. 9 can also have a uniform cross-sectional shape from the one end 521a of the first coupling portion 521 to the other end 521b.

Further, the cross-sectional shape of the reinforcement portion 5211 may be a shape illustrated in FIG. 10. In a case of the reinforcement portion 5211 illustrated in FIG. 10, the cross-sectional shape taken along the plane (YZ plane) orthogonal to the X direction (one direction) also includes the bending portion 7.

Herein, in the reinforcement portion 5211 illustrated in FIG. 10, the bending portion 7 includes the bent portion 71. Specifically, the cross-sectional shape of the reinforcement portion 5211 is formed into an angular U-like shape (bent U-like shape) including three linear portions 73 (two horizontally linear portions 731 and one vertically linear portion 732) and two bent portions 71.

With this shape, stability in the right-and-left direction can be enhanced. Further, the pitch in the horizontal direction can be reduced.

Note that the reinforcement portion 5211 illustrated in FIG. 10 can also have a uniform cross-sectional shape from the one end 521a of the first coupling portion 521 to the other end 521b.

Further, the cross-sectional shape of the reinforcement portion 5211 may be a shape illustrated in FIG. 11. In a case of the reinforcement portion 5211 illustrated in FIG. 11, the cross-sectional shape taken along the plane (YZ plane) orthogonal to the X direction (one direction) also includes the bending portion 7.

Herein, in the reinforcement portion 5211 illustrated in FIG. 11, the bending portion 7 includes the bent portion 71. Specifically, the cross-sectional shape of the reinforcement portion 5211 is formed into a quadrangular shape including four linear portions 73 (two horizontally linear portions 731 and two vertically linear portions 732) and three bent portions 71.

With this shape, stability in the right-and-left direction can also be enhanced. Further, the pitch in the horizontal direction can be reduced.

Note that the reinforcement portion 5211 illustrated in FIG. 11 can also have a uniform cross-sectional shape from the one end 521a of the first coupling portion 521 to the other end 521b.

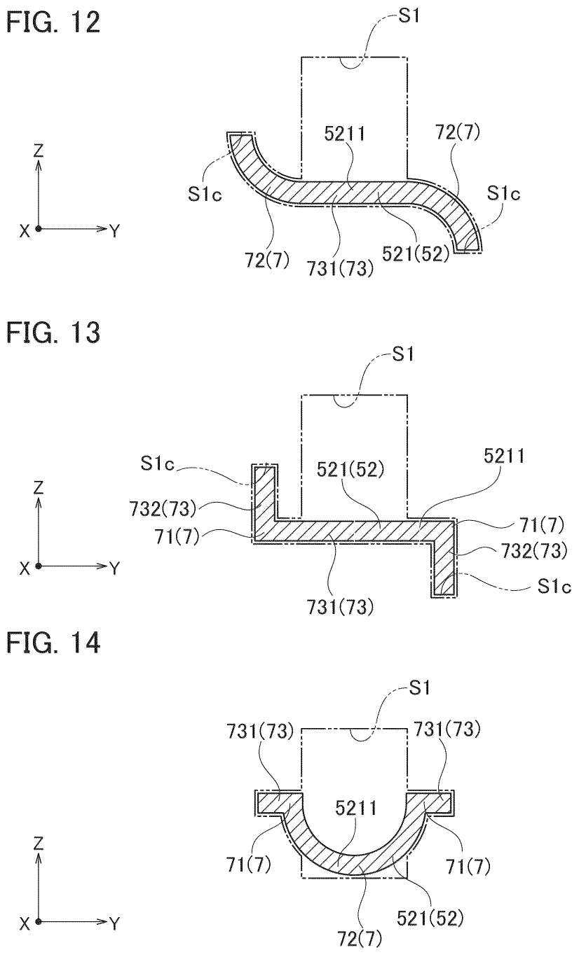

Further, the cross-sectional shape of the reinforcement portion 5211 may be a shape illustrated in FIG. 12. In a case of the reinforcement portion 5211 illustrated in FIG. 12, the cross-sectional shape taken along the plane (YZ plane) orthogonal to the X direction (one direction) also includes the bending portion 7.

Herein, in the reinforcement portion 5211 illustrated in FIG. 12, the bending portion 7 includes the curved portion 72. Specifically, the cross-sectional shape of the reinforcement portion 5211 is formed into a substantially S-like shape including one linear portion 73 (horizontally linear portion 731) and two curved portions 72.

Moreover, in FIG. 12, the width of the reinforcement portion 5211 (the length in the Y direction) is larger than the width of the terminal main body 51, and hence the expansion space S1c having a shape corresponding to the cross-sectional shape of the reinforcement portion 5211 is formed in the upper insertion space S1.

Such an S-like shape is a shape that has satisfactory bending processability at the time of manufacturing, is less prone to wrinkling, and is less prone to cracking. Thus, such a shape can be manufactured easily.

Further, when the cross-sectional shape of the reinforcement portion 5211 is formed into a substantially S-like shape, stability in the right-and-left direction can be enhanced. Further, because the shape is less likely to twist against the housing 1a, movement of the terminal can be suppressed more securely. Moreover, an extended lifespan of a mold die can be achieved.

Note that the reinforcement portion 5211 illustrated in FIG. 12 can also have a uniform cross-sectional shape from the one end 521a of the first coupling portion 521 to the other end 521b.

Further, the cross-sectional shape of the reinforcement portion 5211 may be a shape illustrated in FIG. 13. In a case of the reinforcement portion 5211 illustrated in FIG. 13, the cross-sectional shape taken along the plane (YZ plane) orthogonal to the X direction (one direction) also includes the bending portion 7.

Herein, in the reinforcement portion 5211 illustrated in FIG. 13, the bending portion 7 includes the bent portion 71. Specifically, the cross-sectional shape of the reinforcement portion 5211 is formed into a crank-like shape including one linear portion 73 (horizontally linear portion 731) and two bent portions 71.

Moreover, in FIG. 13, the width of the reinforcement portion 5211 (the length in the Y direction) is larger than the width of the terminal main body 51, and hence the expansion space S1c having a shape corresponding to the cross-sectional shape of the reinforcement portion 5211 is formed in the upper insertion space S1.

Further, when the cross-sectional shape of the reinforcement portion 5211 is formed into a crank-like shape, stability in the right-and-left direction can be enhanced. Further, because the shape is less likely to twist against the housing 1a, movement of the terminal can be suppressed more securely.

Note that the reinforcement portion 5211 illustrated in FIG. 13 can also have a uniform cross-sectional shape from the one end 521a of the first coupling portion 521 to the other end 521b.

Further, the cross-sectional shape of the reinforcement portion 5211 may be a shape illustrated in FIG. 14. In a case of the reinforcement portion 5211 illustrated in FIG. 14, the cross-sectional shape taken along the plane (YZ plane) orthogonal to the X direction (one direction) also includes the bending portion 7.

Herein, in the reinforcement portion 5211 illustrated in FIG. 14, the bending portion 7 includes the bent portion 71 and the curved portion 72. Specifically, the cross-sectional shape of the reinforcement portion 5211 is formed into a shape (a shape obtained by bending distal ends of a U-like shape outward) including two linear portions 73 (two horizontally linear portions 731), two bent portions 71, and one curved portion 72.

With this shape, stability in the up-and-down direction and the right-and-left direction can be enhanced. Further, because the shape is less likely to twist against the housing 1a, movement of the terminal can be suppressed more securely.

Note that the reinforcement portion 5211 illustrated in FIG. 14 can also have a uniform cross-sectional shape from the one end 521a of the first coupling portion 521 to the other end 521b.

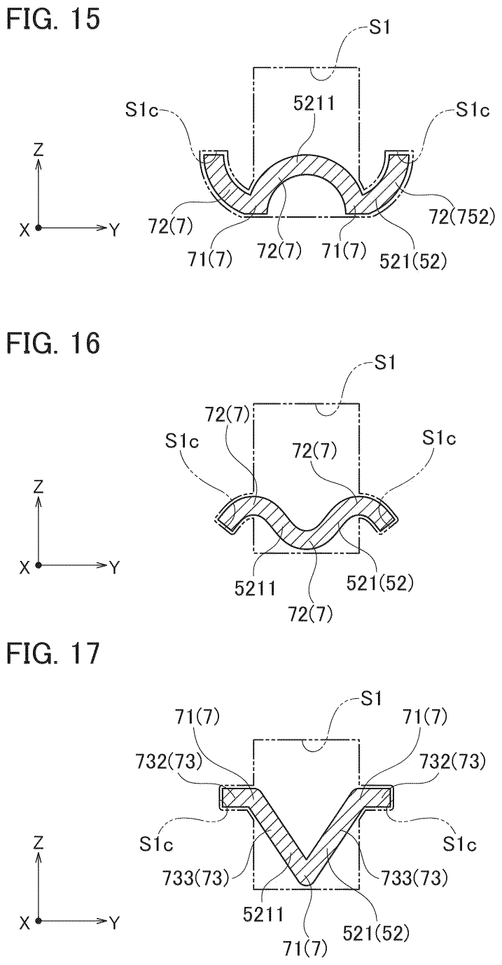

Further, the cross-sectional shape of the reinforcement portion 5211 may be a shape illustrated in FIG. 15. In a case of the reinforcement portion 5211 illustrated in FIG. 15, the cross-sectional shape taken along the plane (YZ plane) orthogonal to the X direction (one direction) also includes the bending portion 7.

Herein, in the reinforcement portion 5211 illustrated in FIG. 15, the bending portion 7 includes the bent portion 71 and the curved portion 72. Specifically, the cross-sectional shape of the reinforcement portion 5211 is formed into a shape (substantially W-like shape) including three curved portions 72 and two bent portions 71.

With this shape, stability in the up-and-down direction and the right-and-left direction can be enhanced. Further, because the shape is less likely to twist against the housing 1, movement of the terminal can be suppressed more securely.

Note that the reinforcement portion 5211 illustrated in FIG. 15 can also have a uniform cross-sectional shape from the one end 521a of the first coupling portion 521 to the other end 521b.

Further, the cross-sectional shape of the reinforcement portion 5211 may be a shape illustrated in FIG. 16. In a case of the reinforcement portion 5211 illustrated in FIG. 16, the cross-sectional shape taken along the plane (YZ plane) orthogonal to the X direction (one direction) also includes the bending portion 7.

Herein, in the reinforcement portion 5211 illustrated in FIG. 16, the bending portion 7 includes the curved portion 72. Specifically, the cross-sectional shape of the reinforcement portion 5211 is formed into a shape (substantially wave-like shape) including three curved portions 72.

With this shape, stability in the up-and-down direction and the right-and-left direction can be enhanced. Further, because the shape is less likely to twist against the housing 1a, movement of the terminal can be suppressed more securely.

Note that the reinforcement portion 5211 illustrated in FIG. 16 can also have a uniform cross-sectional shape from the one end 521a of the first coupling portion 521 to the other end 521b.

Further, the cross-sectional shape of the reinforcement portion 5211 may be a shape illustrated in FIG. 17. In a case of the reinforcement portion 5211 illustrated in FIG. 17, the cross-sectional shape taken along the plane (YZ plane) orthogonal to the X direction (one direction) also includes the bending portion 7.

Herein, in the reinforcement portion 5211 illustrated in FIG. 17, the bending portion 7 includes the bent portion 71. Specifically, the cross-sectional shape of the reinforcement portion 5211 is formed into a shape (a shape obtained by bending distal ends of a V-like shape outward) including four linear portions 73 (two horizontally linear portions 731 and two inclined linear portions) and three bent portions 71.

With this shape, stability in the up-and-down direction and the right-and-left direction can be enhanced. Further, because the shape is less likely to twist against the housing 1a, movement of the terminal can be suppressed more securely.

Note that the reinforcement portion 5211 illustrated in FIG. 17 can also have a uniform cross-sectional shape from the one end 521a of the first coupling portion 521 to the other end 521b.

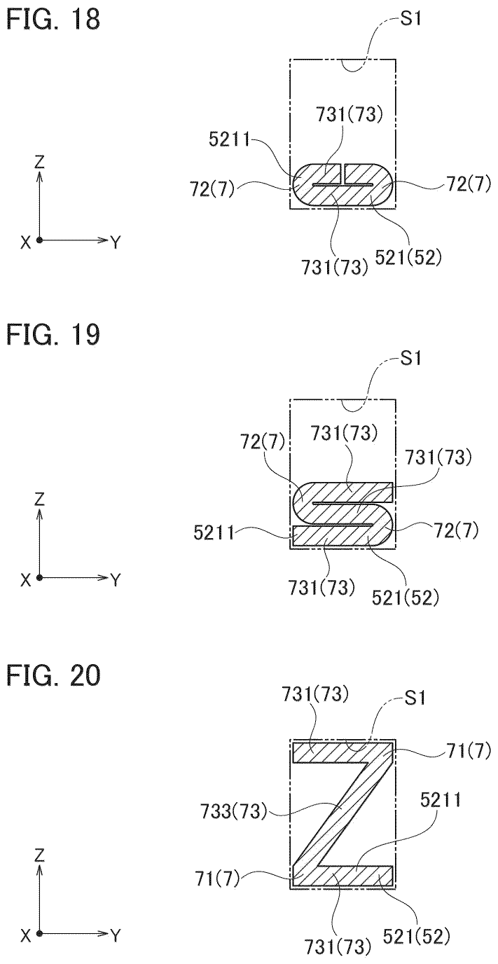

Further, the cross-sectional shape of the reinforcement portion 5211 may be a shape illustrated in FIG. 18. In a case of the reinforcement portion 5211 illustrated in FIG. 18, the cross-sectional shape taken along the plane (YZ plane) orthogonal to the X direction (one direction) also includes the bending portion 7.

Herein, in the reinforcement portion 5211 illustrated in FIG. 18, the bending portion 7 includes the curved portion 72. Specifically, the cross-sectional shape of the reinforcement portion 5211 is formed into a shape (flattened C-like shape: double stacking structure) including three linear portions 73 (three horizontally linear portions 731) and two curved portions 72.

With this shape, the pitch in the vertical direction and the pitch between the terminals can be reduced. Moreover, an extended lifespan of a mold die can be achieved.

Note that the reinforcement portion 5211 illustrated in FIG. 18 can also have a uniform cross-sectional shape from the one end 521a of the first coupling portion 521 to the other end 521b.

Further, the cross-sectional shape of the reinforcement portion 5211 may be a shape illustrated in FIG. 19. In a case of the reinforcement portion 5211 illustrated in FIG. 19, the cross-sectional shape taken along the plane (YZ plane) orthogonal to the X direction (one direction) also includes the bending portion 7.

Herein, in the reinforcement portion 5211 illustrated in FIG. 19, the bending portion 7 includes the curved portion 72. Specifically, the cross-sectional shape of the reinforcement portion 5211 is formed into a shape (flattened S-like shape: triple stacking structure) including three linear portions 73 (three horizontally linear portions 731) and two curved portions 72.

With this shape, the pitch in the vertical direction and the pitch between the terminals can be reduced.

Note that the reinforcement portion 5211 illustrated in FIG. 19 can also have a uniform cross-sectional shape from the one end 521a of the first coupling portion 521 to the other end 521b.

Further, the cross-sectional shape of the reinforcement portion 5211 may be a shape illustrated in FIG. 20. In a case of the reinforcement portion 5211 illustrated in FIG. 20, the cross-sectional shape taken along the plane (YZ plane) orthogonal to the X direction (one direction) also includes the bending portion 7.

Herein, in the reinforcement portion 5211 illustrated in FIG. 20, the bending portion 7 includes the bent portion 71. Specifically, the cross-sectional shape of the reinforcement portion 5211 is formed into a shape (Z-like shape) including three linear portions 73 (two horizontally linear portions 731 and one inclined linear portion) and two bent portions 71.

With this shape, stability in the right-and-left direction can be enhanced. Further, because the shape is less likely to twist against the housing 1a, movement of the terminal can be suppressed more securely. Moreover, the pitch in the horizontal direction can be reduced.

Note that the reinforcement portion 5211 illustrated in FIG. 20 can also have a uniform cross-sectional shape from the one end 521a of the first coupling portion 521 to the other end 521b.

### [Actions and Effects]

The characteristic configurations of the board connector illustrated in the above-mentioned embodiment and the modification examples thereof and effects exerted therefrom are described below.

The board connector 1 illustrated in the above-mentioned embodiment and the modification examples thereof includes the housing 1a in which the insertion space (upper insertion space S1, lower insertion space S2) passing therethrough in the X direction (one direction) is formed. Further, the board connector 1 includes the terminal (upper terminal 5, lower terminal 6) that is inserted to the insertion space (upper insertion space S1, lower insertion space S2) and is held by the housing 1a.

Further, the terminal (upper terminal 5, lower terminal 6) includes the terminal main body 51, 61 that is inserted to the insertion space (upper insertion space S1, lower insertion space S2) and the substrate connection portion 53, 63 that is attached to the FPC substrate (circuit board) 2 while being exposed from the housing 1a. Further, the terminal (upper terminal 5, lower terminal 6) includes the coupling portion 52, 62 that couples the terminal main body 51, 61 and the substrate connection portion 53, 63 to each other.

Further, the coupling portion 52, 62 includes the first coupling portion 521, 621 having the one end 521a, 621a that extends in the X direction (one direction) and is coupled to the terminal main body 51, 61 and the other end 521b, 621b that is exposed from the housing 1a. Further, the coupling portion 52, 62 includes the second coupling portion 522, 622 that extends in the Z direction (a direction intersection with the X direction being the one direction) and is coupled to the substrate connection portion 53, 63. Moreover, the coupling portion 52, 62 includes the third coupling portion 523, 623 that couples the first coupling portion 521, 621 and the second coupling portion 522, 622 to each other.

Herein, the first coupling portion 521 includes the reinforcement portion 5211 having a cross-sectional shape with the bending portion 7, the cross-sectional shape being taken along the plane orthogonal to the X direction (one direction).

The reinforcement portion 5211 includes the exposure portion 52111 that is formed from the other end 521b of the first coupling portion 521 to the insertion opening S1a of the insertion space S1 while the upper terminal (terminal) 5 is held by the housing 1a. Moreover, the reinforcement portion 5211 includes the insertion portion 52112 that is provided continuously to the exposure portion 52111 and is inserted to the insertion space S1.

In this manner, in the board connector 1 illustrated in the above-mentioned embodiment and the modification examples thereof, the first coupling portion 521 includes the reinforcement portion 5211 having a cross-sectional shape with the bending portion 7, the cross-sectional shape being taken along the plane orthogonal to the X direction (one direction). With this, as compared to a terminal having a rectangular cross-sectional shape taken along the plane orthogonal to the X direction (one direction), a cross-sectional secondary moment is increased, and thus the upper terminal (terminal) 5 is less likely to move.

Further, while the upper terminal (terminal) 5 is held by the housing 1a, the reinforcement portion 5211 is formed from the other end 521b of the first coupling portion 521 to the inside of the insertion space S1. In other words, the reinforcement portion 5211 having a cross-sectional shape with the bending portion 7 is formed not only outside the housing 1a but also inside the insertion space S1. With this, the reinforcement portion 5211 can be supported by the housing 1a, and hence the entire part of the upper terminal (terminal) 5, which protrudes from the housing 1a, is less likely to move. As a result, the substrate connection portion 53 formed at the distal end of the upper terminal (terminal) 5 can be prevented more securely from swaying in the up-and-down direction or the right-and-left direction, and positioning accuracy of the substrate connection portion 53 can be improved more.

In this manner, with the board connector 1 illustrated in the above-mentioned embodiment and the modification examples thereof, positioning accuracy the substrate connection portion 53 attached to the FPC substrate (circuit board) 2 can be improved more.

Further, the bending portion 7 may include the bent portion 71.

In this manner, when the reinforcement portion 5211 is formed so that the cross-sectional shape taken along the plane orthogonal to the X direction (one direction) includes the bent portion 71, positioning accuracy of the substrate connection portion 53 can be improved with a simpler configuration.

Further, the bending portion 7 may include the curved portion 72.

In this manner, when the reinforcement portion 5211 is formed so that the cross-sectional shape taken along the plane orthogonal to the X direction (one direction) includes the curved portion 72, a cross-sectional secondary moment of the upper terminal (terminal) 5 can also be increased with a simpler configuration. As a result, positioning accuracy of the substrate connection portion 53 can be improved more easily.

Further, the insertion space S1 may include the expansion space S1c having a shape corresponding to the cross-sectional shape of the reinforcement portion 5211.

With this, the upper terminal (terminal) 5 held by the housing 1a can be prevented more securely from rotating in the housing 1a. As a result, positioning accuracy the substrate connection portion 53 attached to the FPC substrate (circuit board) 2 can be improved more.

### [Others]

While the present embodiment is described above, the present embodiment is not limited thereto, and various modifications may be made within the gist of the present embodiment.

For example, the configurations illustrated in the above-mentioned embodiment and the modification examples thereof may be combined with each other as appropriate.

Further, in the above-mentioned embodiment and the modification examples thereof, there is given an example in which the board connector 1 is attached to the FPC board 2. The board connector 1 may also be attached to a circuit board having rigidity, such as a printed circuit board.

Further, in the above-mentioned embodiment and the modification examples thereof, the terminal (upper terminal 5: female terminal) including the box portion 511 is given as an example. The present disclosure is applicable to a terminal of various types such as a male terminal.

Further, in the above-mentioned embodiment and the modification examples thereof, there is given an example in which the reinforcement portion 5211 is provided only to the upper terminal 5. The reinforcement portion may be provided to both the upper terminal 5 and the lower terminal 6, or the reinforcement portion may be provided only to the lower terminal 6.

Further, in the above-mentioned embodiment and the modification examples thereof, there is given an example in which the terminals (the upper terminal 5 and the lower terminal 6) are to be inserted to the two insertion spaces S1 and S2 in the housing 1a. The present disclosure is applicable to a board connector in which only one insertion space is formed. Further, the present disclosure is also applicable to a board connector in which three or more insertion spaces are formed. In this case, the present disclosure may be applied to all the terminals, or the present disclosure may be applied to only some of the terminals. Further, when the present disclosure is applied to only some of the terminals, the present disclosure is preferably applied to an upper terminal away from a circuit board to which a board connection portion is connected.

Further, in the above-mentioned embodiment and the modification examples thereof, there is given an example in which the reinforcement portion 5211 is provided from the one end 521a of the first coupling portion 521 to the other end 521b. However, it is not required to provide the reinforcement portion 5211 from the one end 521a to the other end 521b. It is only required that the one end of the reinforcement portion 5211 be positioned in the insertion space while the terminal is held by the housing 1a. Thus, it is not required to form the reinforcement portion up to the one end 521a of the first coupling portion 521.

Further, the specifications (a shape, a size, arrangement, and the like) of the housing, the terminal, and the other detail portions may be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A board connector, comprising:
a housing in which an insertion space passing therethrough in one direction is formed; and
a terminal being inserted in the insertion space and being held by the housing, wherein
the terminal includes:
a terminal main body being inserted to the insertion space;
a board connection portion being connected to a circuit board while being exposed from the housing; and
a coupling portion that couples the terminal main body and the board connection portion to each other,
the coupling portion includes:
a first coupling portion having one end extending in the one direction and being coupled to the terminal main body and another end being exposed from the housing;
a second coupling portion extending in a direction intersecting with the one direction and being coupled to the board connection portion; and
a third coupling portion coupling the first coupling portion and the second coupling portion to each other,
the first coupling portion includes a reinforcement portion having a cross-sectional shape with a bending portion, the cross-sectional shape being taken along a plane orthogonal to the one direction, and
the reinforcement portion includes:
an exposure portion formed from the another end of the first coupling portion to an insertion opening of the insertion space while the terminal is held by the housing; and
an insertion portion being provided continuously to the exposure portion and being inserted to the insertion space.

2. The board connector according to claim 1, wherein
the bending portion includes a bent portion.

3. The board connector according to claim 1, wherein
the bending portion includes a curved portion.

4. The board connector according to claim 1, wherein
the insertion space includes an expansion space having a shape corresponding to the cross-sectional shape of the reinforcement portion.
